(19) United States
(12) Patent Application Publication
(10) Pub. No.: US 2004/0190443 A1
(43) Pub. Date: Sep. 30, 2004

(54) Transmission apparatus and concatenation setting method

(75) Inventors: Katsuya Kitamori, Kawasaki (JP); Yasuo Ueda, Kawasaki (JP); Eiji Sugawara, Kawasaki (JP); Eiji Shimose, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/788,487

(22) Filed: Mar. 1, 2004

(30) Foreign Application Priority Data
Mar. 28, 2003 (JP) 2003-092866

(51) Int. Cl. H04L 12/26

(52) U.S. Cl. 370/222

(57) ABSTRACT

A transmission apparatus used for forming a network that supports a bidirectional ring switching capability is provided, in which the transmission apparatus includes: a detecting part for detecting a ring switching request from a received signal; an obtaining part for obtaining an identifier of a transmission apparatus included in the ring switching request, and obtaining concatenation setting information corresponding to the identifier; and a setting part for making concatenation setting for a protection line according to the concatenation setting information.

### BACKGROUND OF THE INVENTION

1. Field of the Invention

The present invention relates to BLSR (Bidirectional Line Switched Ring) technology in a SDH (Synchronous Digital Hierarchy) transmission network. More particularly, the present invention relates to concatenation setting while performing bidirectional ring switching in a transmission apparatus having a cross-connect capability and supporting several types of concatenations.

2. Description of the Related Art

In recent years, BLSR is widely used as a protection switching technology in a SDH (referred to as SONET in North America) transmission network since paths can be efficiently accommodated in BLSR. In addition, the transmission apparatus that forms the ring system provides cross-connect services supporting several types of concatenations so as to flexibly provide paths having various capacities according to requirements of a line user, wherein “concatenation” is a technology for connecting basic units of signals such as AU4 to realize large capacity transmission. For example, concatenation of X AU4s is represented by AU4-Xc.

The concept of BLSR in a four fiber ring system is described with reference to FIG. 1. The ring system shown in FIG. 1 includes seven nodes (node 1-node 7) and four fibers that connects adjacent nodes. Two fibers are assigned to each of the clockwise direction and the counterclockwise direction in the ring system. In each of the two fibers, one is a working line and another is a protection line. In FIG. 1, the solid line indicates the working line and the dotted line indicates the protection line. If a two fiber ring system is used instead of the four fiber ring system, working bandwidth and protection bandwidth are separated in one fiber.

In FIG. 1, there is a path that is added at the node 2 and is dropped at the node 5 in a normal condition. If a failure occurs in the clockwise working and protection lines between the node 3 and node 4, the signal of the path on the failed working line is switched and looped-back to a counterclockwise protection line at the node 3 (this operation is referred to as “bridge” or “send switching”), and the signal is switched to a clockwise working line at the node 4 (this operation is referred to as “switch” or “receive switching”) and the signal is dropped at the node 5, so that the signal on the path is saved.

The above-mentioned BLSR switching control is performed by sending information on switching to each node on the ring by using K1 byte and K2 byte in the section overhead (SOH). The K1 byte and the K2 byte together are called K bytes. Alternatively, the K1 byte and the K2 byte may be called APS bytes since the bytes are used for automatic path switching (APS) control.

FIG. 2 is a block diagram of a conventional transmission apparatus 10 used as a node in the ring in FIG. 1. As shown in FIG. 2, the transmission apparatus 10 includes, in the West side and in the East side, E/O (electrical/optical converters) 13, 14, O/E (optical/electrical converters) 11, 12, overhead insert parts 15, 16, overhead terminating parts 17 18, pointer inserting parts 19, 20, pointer detection parts 21, 22, bridges 23, 24, switches 25, 26, and matrix switches 27, 28. Each of the bridge and the switch is a part for performing signal loopback for recovering a signal as mentioned before. The matrix switch is for determining a route of a signal to be transmitted. “East” and “West” are used for identifying directions in the transmission apparatus. In the figure, “WR” indicates receiving a signal from the West side, and “WS” indicates sending a signal to the West side. In the same way, ER and ES have the similar meaning. “WE” indicates a direction from the West side to the East side, and “EW” indicates a direction from the East side to the West side.

In addition, the transmission apparatus 10 includes a tributary interface 29 and a BLSR control part 30. The tributary interface 29 handles low level signals in SDH that are added or dropped. The BLSR control part 30 performs BLSR control by using the K1 and K2 bytes.

Next, the operation of the transmission apparatus 10 relating to BLSR and concatenation is described.

In a normal state, for example, a signal received from the East side is output to the West side via the matrix switch EW 28. In addition, add/drop of a signal is performed via the tributary interface 29 as necessary.

The overhead termination part 17 or 18 terminates the overhead of a STM signal including the K bytes, and the BLSR control part 30 monitors the K bytes. In addition, the BLSR control part 30 sets the K1 and K2 bytes for sending a switching request for the overhead inserting part 15 (16). The overhead inserting part 15 (16) inserts the K1 and K2 bytes that are set by the BLSR control part 30.

When the transmission apparatus 10 performs BLSR switching, for example, the bridge 24 sends a signal of a working line of the WE direction back to a protection line of the EW direction. The switch 25 sends a signal of the protection line of the EW direction back to a working line of the WE direction. That is, the bridge sends a signal on a working line back to a protection line of a reverse direction, and the switch sends a signal of a protection line back to a working line of a reverse direction. The word “line” in this specification includes meaning of means for transmitting a signal in a transmission apparatus.

The pointer detection part 21 (22) identifies the type of concatenation from pointer bytes in the overhead. The pointer inserting part 19 (20) sets pointer bytes in a signal to be sent on the basis of a pointer detected by the pointer detection part and settings in the transmission apparatus 10. For example, if the pointer bytes are set to indicate “through setting” in which a signal received from East side is sent to the West side as it is, a pointer same as the pointer detected by the pointer detection part 22 is inserted in the pointer inserting part 19.

The type of concatenation is determined by the H1 byte and the H2 byte in the AU pointer in the overhead of the STM signal, in which the type corresponds to the number of basic unit signals to be concatenated. FIG. 3 shows bit assignment of the H1 byte and the H2 byte.

For example, assuming that pointers of AU4-Xc are AU4#1 pointer, AU4#2 pointer, . . . , AU4#X pointer, the concatenation of AU4-Xc can be realized by assigning a normal pointer value to the AU4#1 pointer, and by assigning “1001SS1111111111” (“SS” bits are not defined) to the H1, H2 bytes of each of the AU4#2 pointer, . . . , and AU4#X pointer. The bits “1001SS1111111111” are called CI (Concatenation Indication).

FIG. 4 shows a sequence example for performing BLSR switching control according to the conventional technology. In the figure, information represented by the K1 and K2 bytes (APS bytes) is shown on each arrow between nodes. FIG. 4 shows a case shown in FIG. 1, that is, FIG. 4 shows a case wherein the node 4 detects a signal failure in working and protection lines between the node 3 and the node 4.

Before explaining FIG. 4, the configuration of the APS bytes is described with reference to FIGS.5A and 5B. As shown in FIG. 5A, bit 1 to bit 4 in the K1 byte indicates a switching request (ring/bridge request). The request for ring switching is represented by “SF-R”. Bit 5 to bit 8 in the K1 byte indicates a sending destination of the switching request, bit 1 to bit 4 in the K2 byte indicates the source of the switching request. Bit 5 in K2 byte indicates “long path (L)” or “short path (S)”. Bit 6 to bit 8 indicates a status of multiple section. The short path is defined to be a path that directly links two apparatuses. The long path is defined to be a path that links two apparatuses via another apparatus. For example, SF-R/3/4/L/Idle in FIG. 5B indicates that the cause of switching is SF-R, the send side node is node 3, the source is node 4, long path is used and the status is idle.

In the sequence shown in FIG. 4, when the node 4 detects a signal failure (SF failure) at a time A, the node 4 sends a switching request shown in FIG. 4 to both directions. In the figure, during the time between the time A and the time B, each of intermediate nodes (nodes 1, 2, 5, 6 and 7) that do not perform switch/bridge for the signal to be saved performs full path through setting (referred to as through setting hereinafter) for the protection line in response to receiving the switching request. This setting is performed, because, if the protection line is being used for transmitting a signal, there may be a case where the setting is not set through.

At the time when the switching request sent from the source node 4 arrives at the node 3 (opposite node) via a L path (a route that detours around a ring whose direction is reverse to the ring on which the failure occurred), the node 3 performs bridge control, so that the main signal flows into the protection line from the working line (time C). In the example shown in FIG. 4, bridge control of reverse direction is also performed. In addition, a signal (whose status is Br&Sw) indicating that switching was performed is transmitted to other nodes from each of the node 3 and the node 4.

As to a ring system that includes a plurality of types of concatenations such as AU3, AU4, AU4-4c and AU4-16c, in general, the concatenation type of a signal to be send back to a protection line is different from a concatenation type of a signal flowing in the protection line so far. Thus, it is necessary to match the concatenation type of the protection line with the signal to be sent back the protection line.

Thus, in each node in the conventional technology shown in FIG. 4, the concatenation type of the signal to be sent back is automatically detected by the pointer detection part by using the CI in the pointer bytes, so that each node sends the signal to a next node after setting the concatenation type.

However, according to the above-mentioned concatenation setting method, much time is required for determining the concatenation type in each node due to detection protection operation, so that concatenation setting takes much time and much delay occurs. In FIG. 4, the vertical length of the rectangle indicates the delay time from the time when receiving a detour signal (referred to as Protection detour signal in FIG. 4) to the time when the signal is sent to a next node.

If three stage protection is performed, since one frame in SDH is 125 μsec, 125×3=0.375 msec is necessary for determining the concatenation type. This process is performed in the pointer detection part in a receiving side and in a sending side pointer inserting part. Therefore, delay of 0.375+0.375=0.725 msec occurs per one node. Thus, when 14 nodes, that is the maximum number of relay nodes in BLSR, is used, a delay of 0.725×14 =10.15 msec occurs. That is, as shown in FIG. 4, the main signal is recovered after a lapse of about 10 ms after a signal of the automatic switching protocol goes round the ring.

In BLSR, failure-recovery within 50 msec is the performance requirement. The delay due to concatenation setting constitutes about 20% of 50 msec. In addition, there are transmission delay in each node and transmission delay in optical fiber. Thus, above-mentioned signal recovery delay after switching control constitutes a large share of failure-recovery delay. Therefore, there is a problem in that time assigned for the switching control process is decreased and that a time margin for performing BLSR switching in a plurality of rings in parallel is decreased. The above problem should be solved especially because a transmission apparatus needs to support a plurality of ring systems due to enlargement of the network size.

### SUMMARY OF THE INVENTION

An object of the present invention is to decrease the concatenation setting time in BLSR protection switching to perform failure recovery speedily.

The above object is achieved by a transmission apparatus used for forming a network that supports a bidirectional ring switching capability is provided, in which the transmission apparatus includes: a detecting part for detecting a ring switching request from a received signal; an obtaining part for obtaining an identifier of a transmission apparatus included in the ring switching request, and obtaining concatenation setting information corresponding to the identifier; and a setting part for making concatenation setting for a protection line according to the concatenation setting information.

According to the present invention, by using the identifier included in the ring switching request, the transmission apparatus can determine a specific transmission apparatus that performs ring switching and can determine that a signal of the specific transmission apparatus will be received over a protection line. Thus, by obtaining concatenation setting information corresponding to the identifier, the transmission apparatus can make concatenation setting for the protection line at the time when the ring switching request is received. Thus, it is not necessary to make concatenation setting on the basis of a detouring signal after the switching is performed, so that the delay occurring in the conventional technology can be decreased.

### BRIEF DESCRIPTION OF THE DRAWINGS

Other objects, features and advantages of the present invention will become more apparent from the following detailed description when read in conjunction with the accompanying drawings, in which:

FIG. 1 is a figure for explaining BLSR (Bidirectional Line Switched Ring) technology;

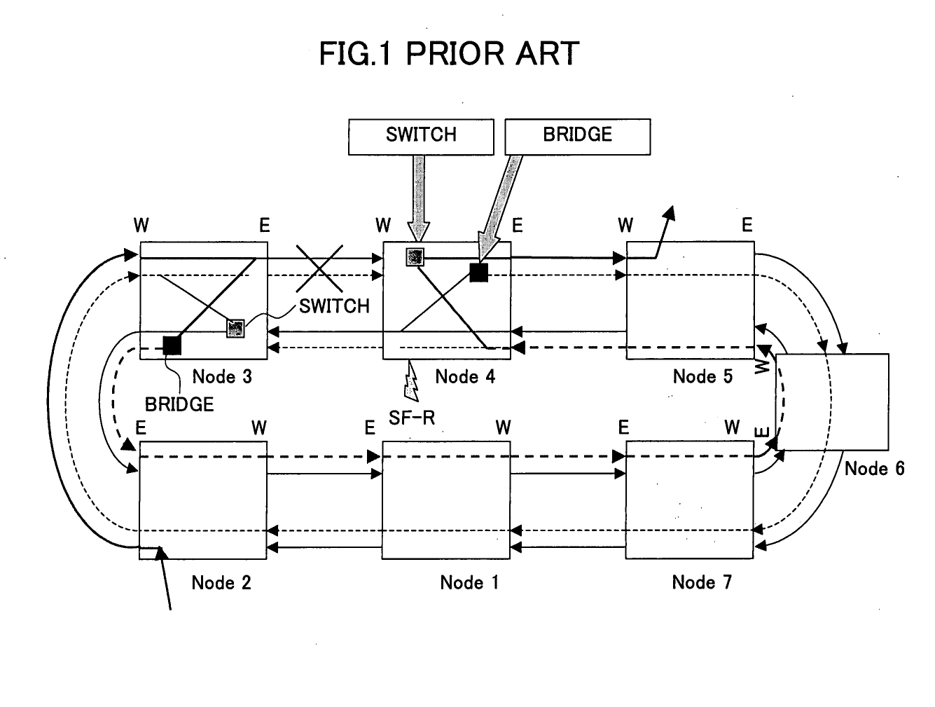

FIG. 2 is a block diagram of a conventional transmission apparatus 10 used as a node in the ring in FIG. 1;

FIG. 3 shows bit assignment of H1 byte and H2 byte;

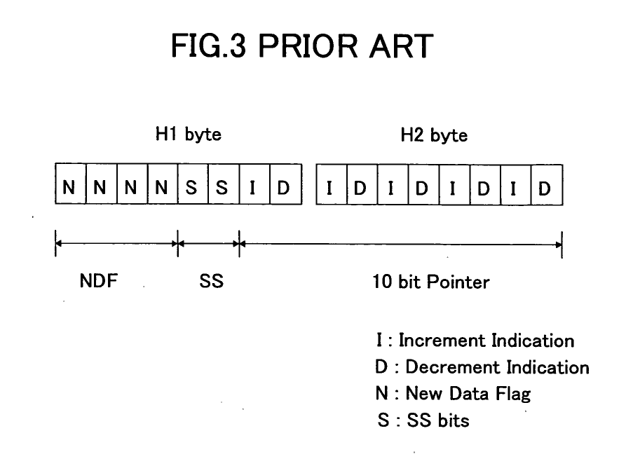

FIG. 4 shows a sequence example for performing BLSR switching control according to the conventional technology;

FIGS.5A and 5B show bit assignment of K1 byte and K2 byte;

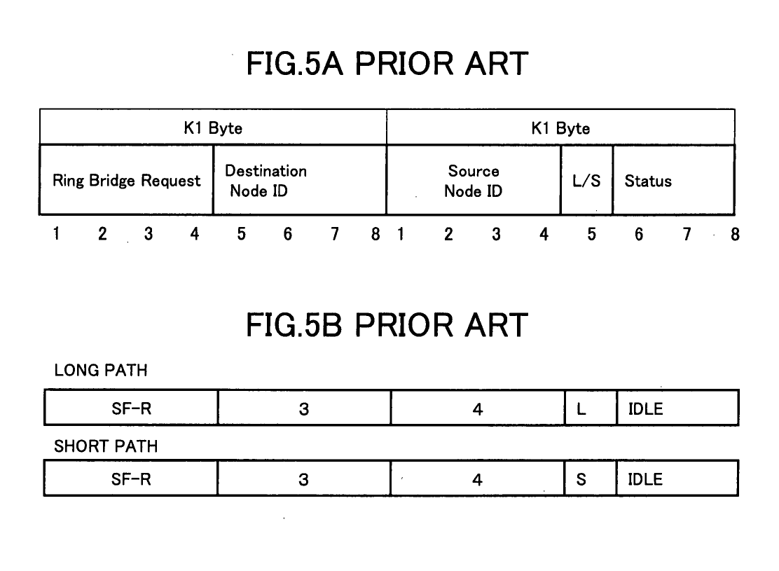

FIG. 6 shows a block diagram of a transmission apparatus according to an embodiment of the present invention;

FIG. 7 shows the concatenation setting information table 44 in detail;

FIG. 8 shows a sequence example of BLSR switching control in a case where the transmission apparatus 40 of the present invention is used for each node;

FIG. 9 is a flowchart in a case where the table setting is performed when concatenation of a working line is changed;

FIG. 10 shows a configuration of the overhead in the case where AU4 is accommodated in STM1; and

FIG. 11 is a flowchart for performing table setting by using a specific command.

### DETAILED DESCRIPTION OF THE PREFERRED EMBODIMENTS

In the following, embodiments of the present invention are described with reference to figures.

In an embodiment of the present invention, each node stores beforehand concatenation setting information of all nodes for a signal flowing on the working line. At the time when a switching request of BLSR is received in each node, a concatenation setting of a source node of the switching request is set in each node for a protection line by referring to the stored concatenation setting information.

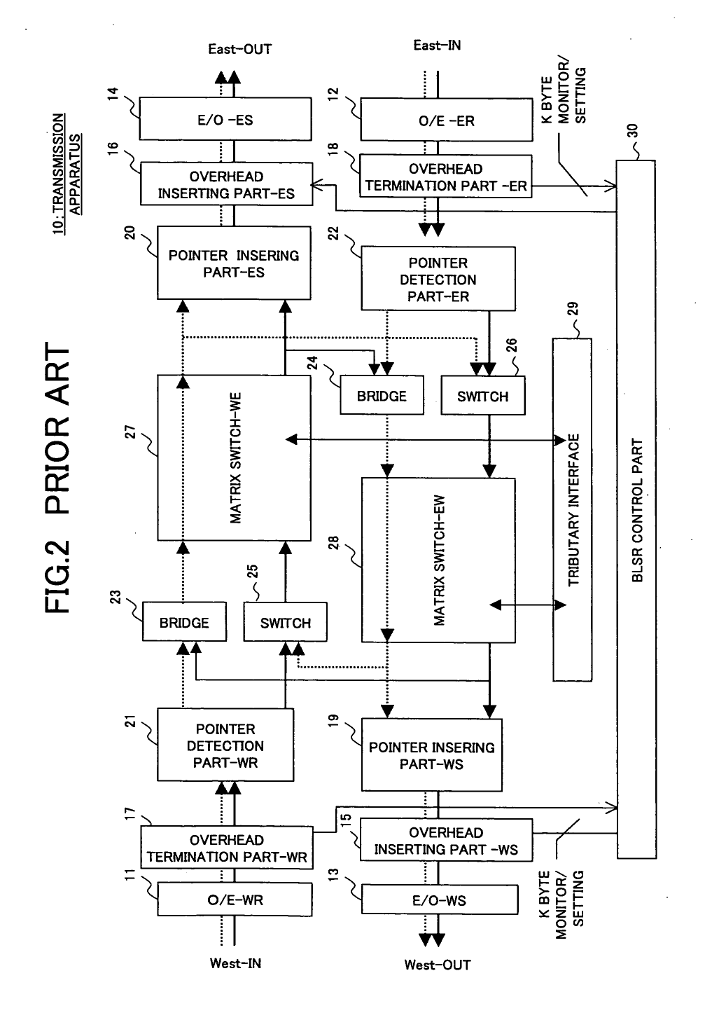

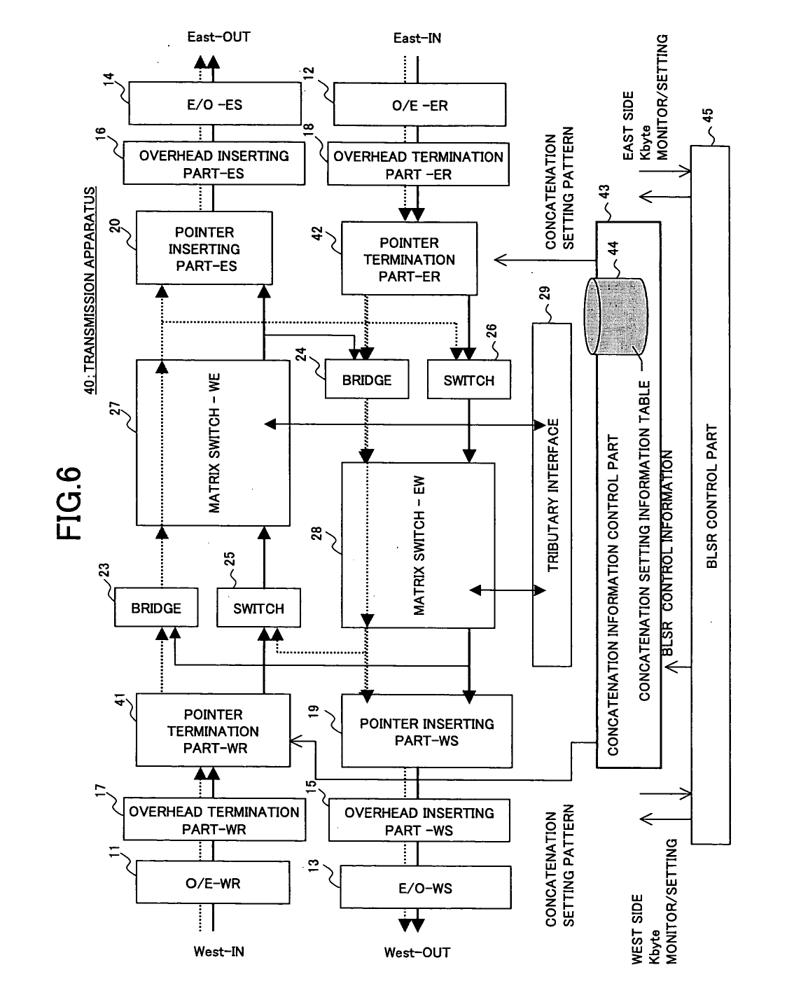

FIG. 6 shows a block diagram of a transmission apparatus according to an embodiment of the present invention. Compared with the transmission apparatus 10 in FIG. 2, the transmission apparatus shown in FIG. 6 includes pointer termination parts 41 and 42 instead of the pointer detection parts 21 and 22, and includes a concatenation information control part 43. The concatenation information control part 43 includes a concatenation setting information table 44. The concatenation setting information table 44 includes concatenation setting patterns for East/West for all nodes that constitute the BLSR ring. The pointer termination part includes a new function in addition to the function of the pointer detection part of the conventional transmission apparatus. In addition to functions of the BLSR control part 30 of the conventional transmission apparatus, the BLSR control part 45 includes a function for passing BLSR control information to the concatenation information control part 43.

The transmission apparatus 40 shown in FIG. 6 operates as follows when BLSR switching is performed in a ring system.

The BLSR control part 45 monitors the K bytes in the overhead termination parts 17, 18, and sends the K bytes to the concatenation information control part 43 as BLSR control information.

The concatenation information control part 43 determines particular nodes that perform switching (switch/bridge) on the basis of source node information and destination node information represented by the K bytes. Then, the concatenation information control part 43 extracts concatenation setting patterns of the nodes from the concatenation setting information table 44, so that the pointer termination parts 41, 42 perform concatenation setting process.

In a normal state, each of the pointer termination parts 41 and 42 detects a pointer in the same way as the conventional pointer detection parts 21, 22. When the pointer termination part receives the concatenation setting instruction from the concatenation information control part 43, the pointer termination part stops determining CI of received pointer bytes, and determines a concatenation type according to the concatenation setting pattern instructed from the concatenation information control part 43.

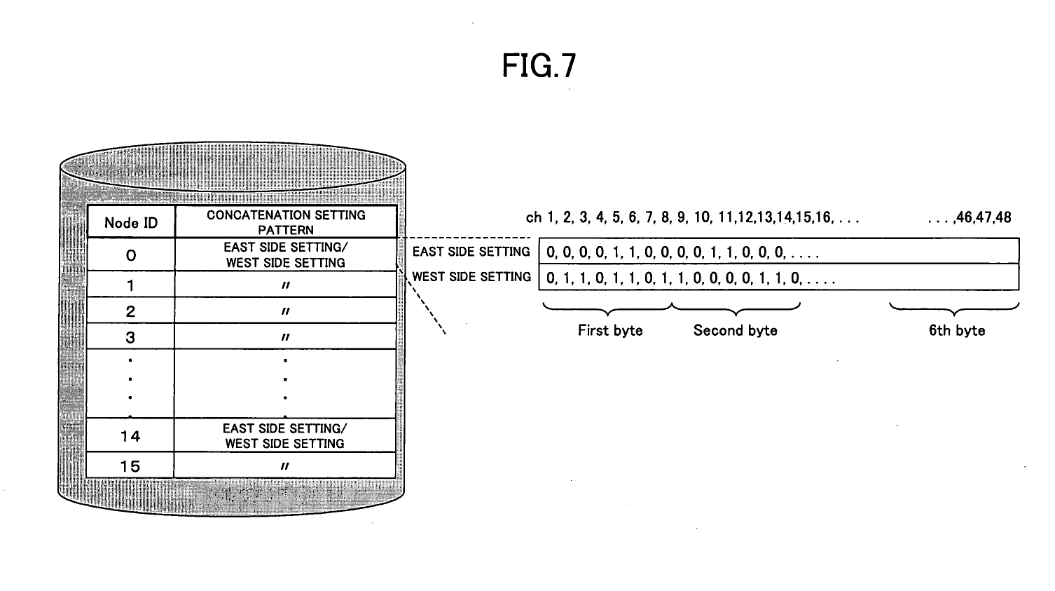

FIG. 7 shows the concatenation setting information table 44 in detail.

As shown in FIG. 7, East side setting data and West side setting data of concatenation for a working line are stored for each node ID. The setting data in the table indicates concatenation setting of a side receiving the pointer.

In the setting pattern in this embodiment, one bit is assigned to each channel (for example AU3), in which a head channel is 0, and each subordinate channel sequentially connected to the head channel is 1.

For example, if the bit pattern is 0, 1, 1, 0, the second and third channels are subordinate channels connected to the first channel, which represents a concatenation in which three channels are concatenated. The length of the concatenation setting pattern corresponds to the number of concatenated channels. For example, 48 bits are necessary for performing signal transmission of STM 16 (that corresponds to OC 48 in SONET), and 192 bits are necessary for STM 64 (OC 192 in SONET). On the basis of information in the concatenation setting information table, the concatenation information control part 43 performs following determination according to information in the K bytes.

If the SF-R switching request is received from the West (West-IN) side, the concatenation information control part 43 extracts a West side concatenation setting pattern of a switching request source node ID indicated by the K bytes, and instructs the pointer termination part 42 (ER) to set the pattern. In addition, the concatenation information control part 43 instructs the pointer termination part 41 (WR) to set an East side concatenation setting pattern of a destination node ID indicated by the K bytes.

If the SF-R switching request is received from the East (East-IN) side, the concatenation information control part 43 extracts an East side concatenation setting pattern of a switching request source node ID indicated by the K bytes, and instructs the pointer termination part 41 (WR) to set the pattern. In addition, the concatenation information control part 43 instructs the pointer termination part 42 (ER) to set a West side concatenation setting pattern of a destination node ID indicated by the K bytes. Since full path through setting is made in intermediates nodes, a concatenation setting that is determined in a pointer termination part is inserted in a signal in the corresponding pointer inserting part in each intermediate node.

In the above-mentioned example, the concatenation setting is made in both sides (West and East). However, in a case where a protection line of only one side is used for signal recovery, the concatenation setting may be made only for the one side.

The above-mentioned setting is made in each node that received the SF-R switching request. For example, assuming that the node 2 receives, from the East side, SF-R/4/3/L/Idele from the node 3 when line failure occurs, the node 2 extracts an East side concatenation setting pattern of the source node 3 from the concatenation setting information table of the node 2, in which the East side concatenation setting pattern is a pattern used by the node 3 for receiving a signal on a counterclockwise working line. Then, the node 2 instructs the pointer termination part 41 (WR) (receive side of clockwise protection line signal) of the node 2 to set the pattern. In addition, the node 2 instructs the pointer termination part 42 (ER) to set a West side concatenation setting pattern of the destination node 4, in which the West side concatenation setting pattern is a pattern used by the node 4 to receive a signal of a clockwise working line. By making such pattern setting in each node, concatenation setting same as that of a line to be recovered can be made in each node.

As mentioned above, by making the concatenation setting in each node in advance in response to receiving a switching request, the concatenation setting delay can be decreased compared with the conventional setting method in which the setting is performed when the bridged main signal is transmitted on a protection line through each node after each node received the switching request.

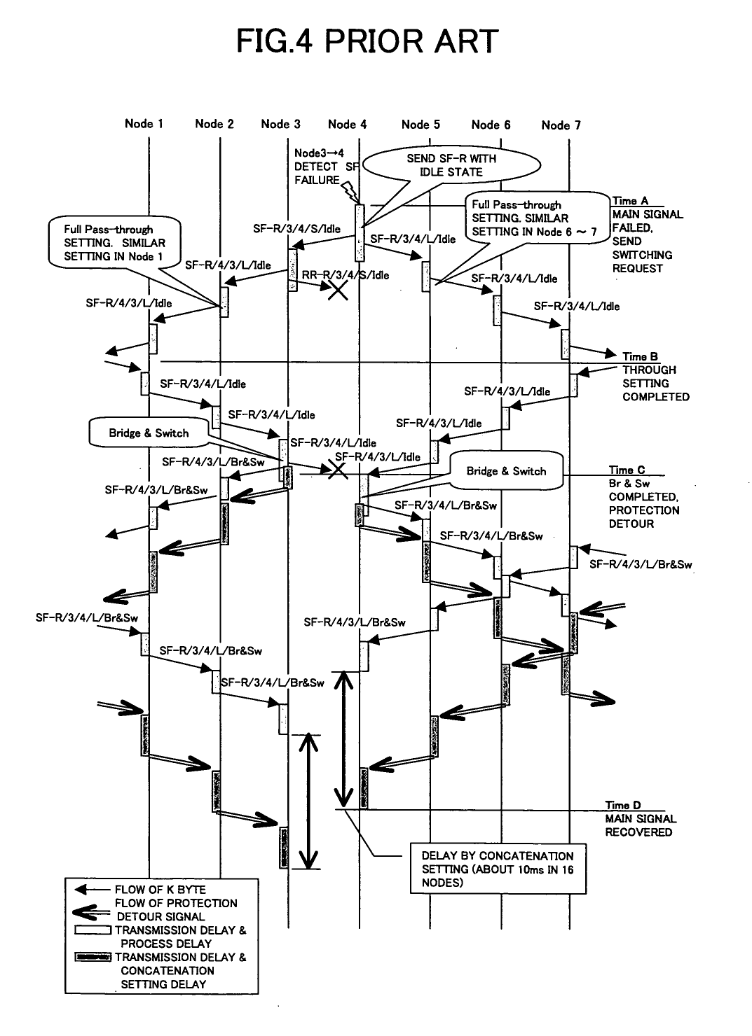

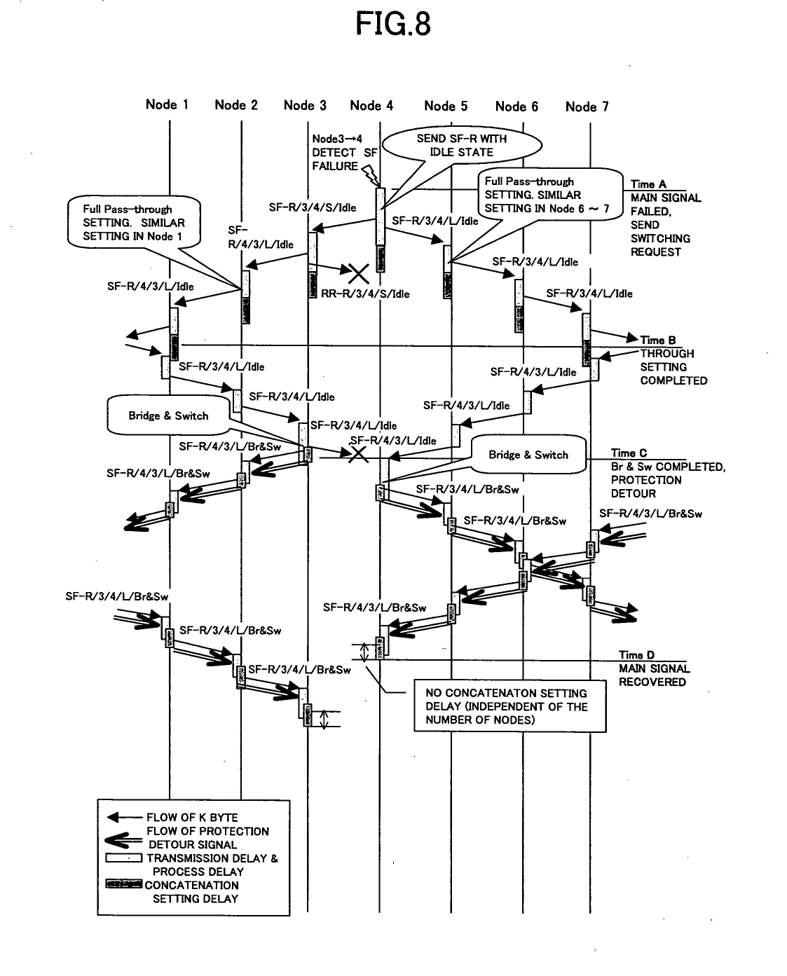

FIG. 8 shows a sequence example of BLSR switching control in a case where the transmission apparatus 40 of the present embodiment is used for each node. FIG. 8 shows an example, same as the example shown in FIG. 4, in which the node 4 detects signal failure in working and protection lines between the node 3 and the node 4.

When the node 4 detects the signal failure, the node 4 sends a switching request to both directions. During the time A to time B, each node that receives the switching request makes full path through setting and sends the switching request to an adjacent node, and performs the concatenation setting process. That is, each node identifies the source and the destination of the received K1 and K2 bytes, and extracts concatenation setting patterns from the own concatenation setting information table on the basis of the source and the destination, and makes concatenation settings. That is, the setting pattern is notified to the pointer termination part, and the pointer termination part determines concatenation setting by using the notified concatenation setting pattern.

In the figure, during time from time A to time B, each node, node 2 for example, receives the switching request, and analyzes the request and sends the same switching request to the node 1. In addition, the node 2 makes full path through setting and above-mentioned concatenation setting. As shown in node 2 in FIG. 8, the vertical length of the first rectangular indicates a time for receiving the switching request, sending the switching request to the node 1, and making full path through setting. The vertical length of the next rectangular indicates a time for making above-mentioned concatenation setting.

After the switching request goes round the ring, switching (bridge/switch) is performed in the nodes 3 and 4 (time C), and information indicating that the switching was performed is transmitted to each node. Also, a detouring signal flows into the protection line. Conventionally, each node makes concatenation setting by detecting a pointer of the detouring signal. On the other hand, according to the present invention, since the concatenation setting has already been made, delay for making the setting does not occur while the detouring signal is transmitted. That is, as shown in FIG. 4, according to the conventional technique, a node receives a signal in which the state is Br&Sw and sends the signal to a next node. After that, after a lapse of considerable delay time, the detouring signal is transmitted. The delay is due to making concatenation setting. On the other hand, according to the present invention, as shown in FIG. 8, the delay that occurs in the conventional technology does not occur, and the detouring signal goes round the ring almost simultaneously with the signal of Br&Sw. Therefore, the main signal can be recovered without a delay of about 10ms that was occurred conventionally.

As mentioned above, in the process of transmitting the switching request from a node that issues the switching request to the opposite node through each intermediate node, concatenation setting can be made in advance in each node on the detouring route. Therefore, when the signal flows into the protection line after switching (bridge) is performed by the opposite node, there occurs no delay due to concatenation setting process.

(Setting Method for Setting Concatenation Setting Information Table)

Next, the setting methods for setting the concatenation setting information table that is used for the above-mentioned concatenation setting method are described.

The concatenation settings in East/West sides are determined by cross-connect setting, and the concatenation settings are reflected to signals on working lines. The concatenation setting pattern is obtained by coding the concatenation state determined by the cross-connect setting. In the present embodiment, each node stores, in the concatenation setting information table, concatenation setting patterns including patters of the own node and patters of the other nodes on the ring.

More specifically, a node adds an ID of the node to the own concatenation setting patterns and sends the own patterns with the ID to every node on the ring. Then, each node stores received concatenation setting patterns in a storage (memory and the like) of the own node in association with corresponding IDs as the concatenation setting information table.

The concatenation setting information table may be made or updated when concatenation setting in a working line is changed, for example. Alternatively, the table can be changed when any node ID is changed or when instructed to do so by a command issued by an operator.

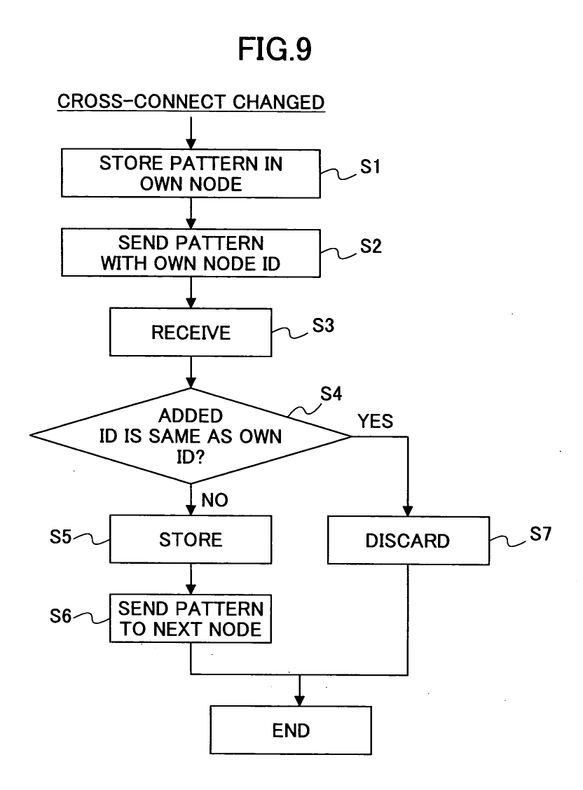

Next, the setting method of the table is described in detail. FIG. 9 is a flowchart in the case where the table is set when concatenation of a working line is changed.

In a ring system that supports BLSR, when cross-connect setting is changed to drop cross-connect or through cross-connect and the like in relation to change of line usage, a node (that may be referred to as “source node” hereinafter) where the cross-connect setting is changed stores concatenation setting patterns in an area corresponding to the own node in the concatenation setting information table 44 in the concatenation information control part 43 in step S1. That is, the concatenation setting patterns are determined by the cross-connect setting, and the concatenation setting patterns are stored in the area corresponding to the own node, that is, corresponding to the own node ID.

Then, the concatenation information control part 43 adds the own node ID to the concatenation setting patterns generated by changing the cross-connect setting, and sends the concatenation setting patterns with the node ID to the other nodes on the ring by using available bits in the overhead in the signal in step S2.

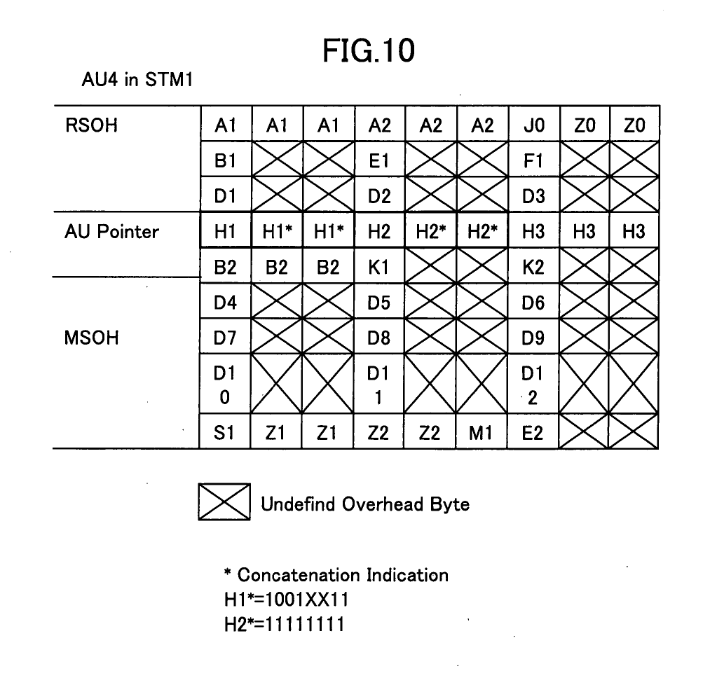

FIG. 10 shows a configuration of the overhead in the case where AU4 is accommodated in STM1. The undefined regions in the figure are available regions. As mentioned before, even in the case of STM 16, the concatenation setting pattern uses only 48 bits×2, that is, 12 bytes. Therefore, there is enough available space even in STM1 as shown in FIG. 10. In the case of STM16, larger available space can be obtained. As to AU4, CI may be used for each of remaining two AU pointers in the three AU pointers.

After the concatenation information control part 43 sends the concatenation setting patterns to the other nodes, a node that receives the concatenation setting patterns in step S3 stores the concatenation setting patterns in an area corresponding to the node ID of the received concatenation setting patterns in a concatenation setting information table of the own node in step S5 if the node ID of the received concatenation setting patterns is not the same as the node ID of the own node (No in step S4). The node sends the received concatenation setting patterns with the source node ID to a next node in step S6.

At the time when the concatenation setting patterns goes around the ring and returns to the source node that starts to send the patterns, the source node discards the pattern information (Yes in step S4 and step S7).

As mentioned above, each node sends concatenation setting patterns that are changed due to change of cross-connect setting to the other nodes. Thus, all nodes can share line operation information that indicates concatenation types of signals.

Since the change of the cross-connect setting is reflected to the concatenation setting information table, each node can hold a concatenation setting information table based on the newest state.

There is a case where a node ID is changed by a change command due to change of network configuration and the like. In such a case, by sending information with the new ID to every node in response to issuing the change command, the concatenation setting information table can be updated in every node. More specifically, in the same way as the above-mentioned change of cross-connect setting, a node (source node) at which the node ID is changed sends its concatenation setting patterns with its new node ID to a next node. The next node sends the patterns with the ID to another node one after another. Each node that received the concatenation setting patterns with the ID updates the concatenation setting information table of the own node. Instead of sending the concatenation setting patterns with the new node ID, the node may send the old node ID and the new node ID to each node.

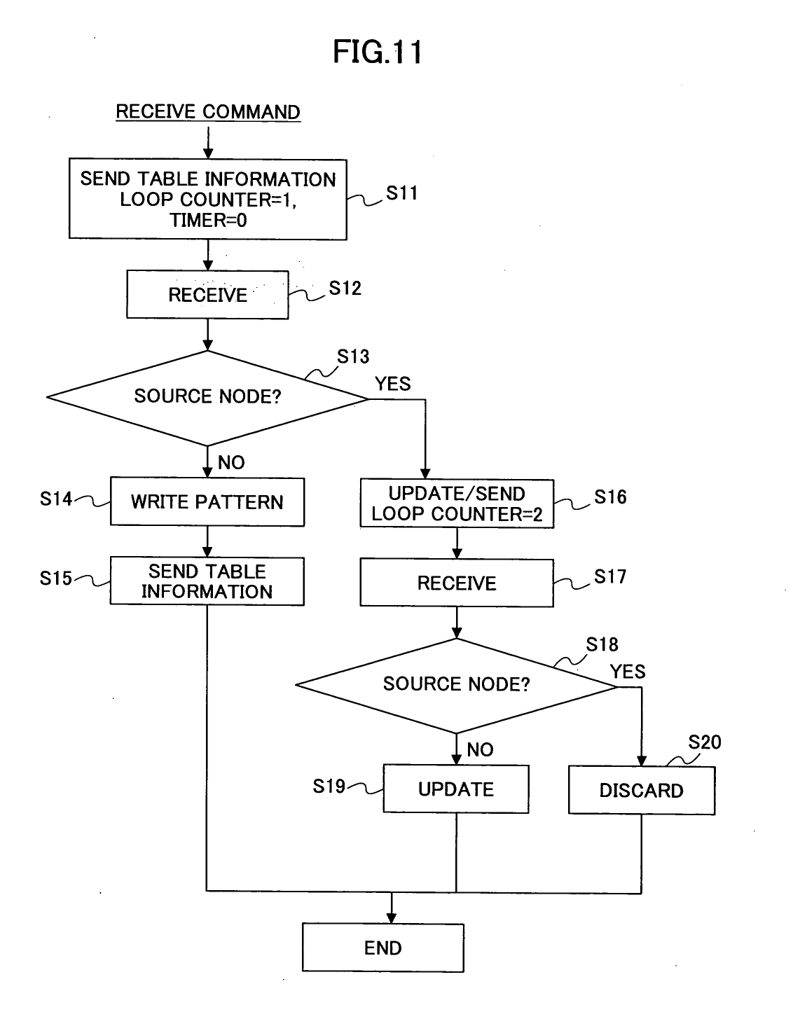

Next, a case where a specific command is used is described with reference to a flowchart of FIG. 11. Assuming that this command is INIT-CNCT, for example.

When the command is issued from a monitoring apparatus and the like, a node receives the command. The node that receives the command adds the own node ID to the concatenation setting information table of the own node. Then, the node sets “1” in a loop counter and initializes an operation counter. After that, the node sends information (referred to as table information hereinafter) in the own concatenation setting information table to a next node by using the overhead in step S11. The next node receives the table information. If the node is not the source node that received the command first (No in step S13), the node writes the concatenation setting patterns of the own node in a field corresponding to the own node ID in the table information in step S14. Then, the node sends the table information to a next node in step S15.

When the table information returns to the source node (node that issues INIT-CNCT) having the same node ID as one added to the table information (Yes in step S13), the source node updates its concatenation setting information table with the returned table information, wherein the table information has been updated with the newest information of all nodes. Then, the source node sets “2” in the loop counter, and sends the table information over the network again in step S16. Each node other than the source node updates its concatenation setting information table with the table information in which the loop counter is 2 (step S17, No in step S18, step S19).

When the source node receives the table information in which the loop counter is 2 (Yes in step S18), the source node discards the table information and clears the operation timer in step S20. In addition, the source node notifies an operator of update completion by using a report.

If the table information does not return to the source node due to a line failure and the like so that timeout occurs, the source node notifies the operator of the failure of table update. By using the operation timer, the operator can recognize failure of delivery of the table information.

According to the above-mentioned methods, every time when the concatenation setting patterns or the node ID change, updated concatenation setting information can be delivered to every node on the ring. Thus, each node can automatically hold the newest correct concatenation setting information.

In the above-mentioned embodiment, each node has the concatenation setting information table and determines concatenation setting patterns according to node IDs indicated in a switching request. Alternatively, the concatenation setting information table may be held by one node. In this case, when the one node receives a switching request, the node sends concatenation setting patterns corresponding to node IDs indicated in the switching request to each node with K1, K2 bytes by using the overhead.

As mentioned above, according to the present invention, a transmission apparatus used for forming a network that supports a bidirectional ring switching capability is provided, in which the transmission apparatus includes: a detecting part for detecting a ring switching request from a received signal; an obtaining part for obtaining an identifier of a transmission apparatus included in the ring switching request, and obtaining concatenation setting information corresponding to the identifier; and a setting part for making concatenation setting for a protection line according to the concatenation setting information.

According to the present invention, by using the identifier included in the ring switching request, the transmission apparatus can determine a specific transmission apparatus that performs ring switching and can determine that a signal of the specific transmission apparatus will be received over a protection line. Thus, by obtaining concatenation setting information corresponding to the identifier, the transmission apparatus can make concatenation setting for the protection line at the time when the ring switching request is received. Thus, it is not necessary to make concatenation setting on the basis of a detouring signal after the switching is performed, so that the delay occurring in the conventional technology can be decreased.

In the transmission apparatus, the obtaining part comprising; a storing part for storing pieces of concatenation setting information of transmission apparatuses on the network in association with identifiers of the transmission apparatuses; wherein the obtaining part obtains the concatenation setting information from the storing part. Therefore, the concatenation setting information can be obtained speedily.

The obtaining part may obtain the concatenation setting information from information received from another transmission apparatus. In this case, a specific apparatus on the network sends the concatenation setting information with a ring switching request.

The transmission apparatus may further includes: a detecting part for detecting concatenation setting in the transmission apparatus; and a sending part for adding the own identifier of the transmission apparatus to concatenation setting information corresponding to the concatenation setting and sending the concatenation setting information with the own identifier to another transmission apparatus.

According to the present invention, newest concatenation setting information can be sent over the ring network, so that each transmission apparatus can store newest concatenation setting information.

In the transmission apparatus, when the own identifier is changed, the sending part may add the changed identifier to the concatenation setting information and send the concatenation setting information with the changed identifier to another transmission apparatus. Accordingly, even when the identifier is changed, concatenation setting information including the new identifier can be stored in each transmission apparatus.

The transmission apparatus may further includes: a part for adding the own identifier to first pieces of concatenation setting information stored in the storing part and sending the first pieces of concatenation setting information with the own identifier to another transmission apparatus in response to receiving a predetermined command; and a part for receiving second pieces of concatenation setting information from another transmission apparatus, writing own concatenation setting information into the received second pieces of concatenation setting information, and sending the second pieces of concatenation setting information to another transmission apparatus. According to the present invention, the concatenation setting information can be updated in each transmission apparatus only by issuing a command by an operator.

As mentioned above, according to the present invention, the concatenation setting delay caused by making concatenation setting when the main signal flows in a detouring protection line can be eliminated, so that signal recovery by switching can be performed speedily. In addition, since concatenation setting information can be set automatically in each node, the concatenation setting method can be realized without increasing working load of the operator and setting mistakes and the like. In addition, since time margin for BLSR control can be increased, one processor can take charge of more BLSR switching controls, so that a reliable transmission service can be provided at low cost.

The present invention is not limited to the specifically disclosed embodiments, and variations and modifications may be made without departing from the scope of the present invention.

What is claimed is:

1. A transmission apparatus used for forming a network that supports a bidirectional ring switching capability, the transmission apparatus comprising:
a detecting part for detecting a ring switching request from a received signal;
an obtaining part for obtaining an identifier of a transmission apparatus included in the ring switching request, and obtaining concatenation setting information corresponding to the identifier; and
a setting part for making concatenation setting for a protection line according to the concatenation setting information.

2. The transmission apparatus as claimed in claim 1, the obtaining part comprising;
a storing part for storing pieces of concatenation setting information of transmission apparatuses on the network in association with identifiers of the transmission apparatuses;
wherein the obtaining part obtains the concatenation setting information from the storing part.

3. The transmission apparatus as claimed in claim 1, wherein the obtaining part obtains the concatenation setting information from information received from another transmission apparatus.

4. The transmission apparatus as claimed in claim 2, the transmission apparatus further comprising:
a detecting part for detecting concatenation setting in the transmission apparatus; and
a sending part for adding the own identifier of the transmission apparatus to concatenation setting information corresponding to the concatenation setting and sending the concatenation setting information with the own identifier to another transmission apparatus.

5. The transmission apparatus as claimed in claim 4, wherein, when the own identifier is changed, the sending part adds the changed identifier to the concatenation setting information and sends the concatenation setting information with the changed identifier to another transmission apparatus.

6. The transmission apparatus as claimed in claim 4, the transmission apparatus further comprising:
a part for adding the own identifier to first pieces of concatenation setting information stored in the storing part and sending the first pieces of concatenation setting information with the own identifier to another transmission apparatus in response to receiving a predetermined command; and
a part for receiving second pieces of concatenation setting information from another transmission apparatus, writing own concatenation setting information into the received second pieces of concatenation setting information, and sending the second pieces of concatenation setting information to another transmission apparatus.

7. A concatenation setting method in a transmission apparatus used for forming a network that supports a bidirectional ring switching capability, the method comprising the steps of:
detecting a ring switching request from a received signal;
obtaining an identifier of a transmission apparatus included in the ring switching request, and obtaining concatenation setting information corresponding to the identifier; and
making concatenation setting for a protection line according to the concatenation setting information.

8. The method as claimed in claim 7, wherein the transmission apparatus comprises a storing part for storing pieces of concatenation setting information of transmission apparatuses on the network in association with identifiers of the transmission apparatuses;
wherein the transmission apparatus obtains the concatenation setting information from the storing part.

9. The method as claimed in claim 7, wherein the transmission apparatus obtains the concatenation setting information from information received from another transmission apparatus.

10. The method as claimed in claim 8, the method further comprising the steps of:
detecting concatenation setting in the transmission apparatus; and
adding the own identifier of the transmission apparatus to concatenation setting information corresponding to the concatenation setting and sending the concatenation setting information with the own identifier to another transmission apparatus.

11. The method as claimed in claim 10, wherein, when the own identifier is changed, the transmission apparatus adds the changed identifier to the concatenation setting information and sends the concatenation setting information with the changed identifier to another transmission apparatus.

12. The method as claimed in claim 10, the method further comprising the steps of:
adding the own identifier to first pieces of concatenation setting information stored in the storing part and sending the first pieces of concatenation setting information with the own identifier to another transmission apparatus in response to receiving a predetermined command; and
receiving second pieces of concatenation setting information from another transmission apparatus, writing own concatenation setting information into the received second pieces of concatenation setting information, and sending the second pieces of concatenation setting information to another transmission apparatus.
